(19) United States
(12) Patent Application Publication
(10) Pub. No.: US 2003/0152677 A1
(43) Pub. Date: Aug. 14, 2003

(54) Solid fat based materials as flow agents

(75) Inventors: Kevin Rabinovitch, Hackettstown, NJ (US); Shane Benedict, Hackettstown, NJ (US)

Correspondence Address: FITZPATRICK CELLA HARPER & SCINTO, 30 ROCKEFELLER PLAZA, NEW YORK, NY, 10112, US

(73) Assignee: Mars, Incorporated, McLean, VA (US)

(21) Appl. No.: 10/345,044

(22) Filed: Jan. 15, 2003

Related U.S. Application Data
(60) Provisional application No. 60/349,141, filed on Jan. 15, 2002.

(51) Int. Cl. A23G 1/00; A23L 1/216

(52) U.S. Cl. 426/289

(57) ABSTRACT

The present invention is directed to a method of reducing adhesion between confectionery articles stored or processed in contacting relationships. The method comprises the step of applying a solid fat based material to the confectionery articles in an amount effective to substantially reduce adhesion when the confectionery articles are in contacting relationships, thereby reducing adhesion of the confectionery articles to one another.

### CROSS REFERENCE TO RELATED APPLICATIONS

This application claims the benefit of U.S. Provisional Application No. 60/349,141, filed on Jan. 15, 2002.

### BACKGROUND OF THE INVENTION

1. Field of the Invention

The present invention relates to a method for reducing adhesion and improving the flowability of confectionery articles over and between one another. More particularly, the present invention relates to the use of a solid fat based material that reduces adhesion and/or facilitates the flow of confectionery articles during processing or after packaging.

2. Description of the Related Art

In the production of confectionery articles, such as intermediate confectionery centers, various product handling issues may arise. For example, confectionery centers may be stored or held for periods of time where the product is in contact with other pieces. The center pieces are usually somewhat tacky and as a result they tend to stick together. Lowering the temperature of the articles tends to reduce the stickiness and is one way that this problem was handled in the prior art. The problem with working at a lower temperature is that some processing operations cannot be properly performed and additional resources are expended (e.g., utilities). For example, chocolate coating is difficult to perform on confectionery articles that are too cold, producing unsatisfactory and spotty results. An alternate method is needed to reduce the adhesion problem that is created during storage and handling of the confectionery articles.

### SUMMARY OF THE INVENTION

The present invention is directed to a method of reducing adhesion between confectionery articles stored or processed in contacting relationships. The method comprises the step of: applying a solid fat based material to the confectionery articles in an amount effective to substantially reduce adhesion when the confectionery articles are in contacting relationships, thereby reducing adhesion of the confectionery articles to one another.

In one embodiment, the method for reducing adhesion and improving flow is directed to confectionery centers. The method comprises the steps of: (a) providing a sheet having confectionery centers throughout; (b) separating the confectionery centers from the sheet; and (c) applying a solid fat based material to the confectionery centers in an amount effective to substantially reduce adhesion when the confectionery centers are in contacting relationships.

In another embodiment, the method for reducing adhesion and improving flow comprises the steps of: (a) providing a sheet having confectionery centers throughout; (b) applying a solid fat based material to the sheet of confectionery centers in an amount effective to substantially reduce adhesion when the confectionery centers are in contacting relationships; and (c) separating the confectionery centers from the sheet into discrete pieces.

### DETAILED DESCRIPTION OF THE INVENTION

The present invention is directed to a method of reducing adhesion and improving flow between confectionery articles. Confectionery articles that are or will be placed in contact with other confectionery articles are taken and treated by applying a solid fat based material that acts as a flow agent. This reduces adhesion and improves the flow of the confectionery articles over one another. A mixing step may be included in the method, to improve the coverage and spread of the solid fat based material over the confectionery articles.

As used herein, contacting relationship simply means that at least one confectionery article is in contact with at least one other confectionery article or the surface of a piece of process equipment. Of course a confectionery article may be in contact with more than one other confectionery article or surface. A preferred confectionery article is a confectionery center.

Adhesion results in either the formation of a clump when two or more confectionery articles stick together or the formation of build-up when confectionery articles adhere to process surfaces. For many common confectionery materials used in low contact processes, e.g., slabbing, slitting and enrobing, low levels of adhesion are expected. This is because there is less contacting opportunities. Conversely, high levels of adhesion would be expected in high contact process, such as panning. The severity of adhesion can be defined by the mass fraction of product that remains as discrete, individual pieces -referred to as the unadhered mass fraction. For many materials, in the absence of the invention taught here, the unadhered mass fraction could be as low as 25% or lower. With the invention, it has been found that the unadhered mass fraction can be raise to be greater than 60%. In a preferred embodiment it is raised to greater than 70%. More preferrably the unadhered mass fraction is raised to be greater than 80%. Even more preferrably it is greater than 90% and in the most preferred embodiment, greater than 95% of the mass in the bed remains as discrete, individual confectionery articles.

The confectionery articles may take the form of a variety of different confectionery products. They may or may not be tacky and the confectionery articles may be the same or different. Suitable confectionery articles include for example, confectionery centers, hard candies, jujubes, and the like.

The solid fat based material may be applied at any time during processing or packaging operations. When added during processing, the solid fat based material functions as a processing aid, i.e. flow agent, making handling of the confectionery articles easier. Alternatively, the solid fat based material can be added just prior to the packaging of the confectionery article. This reduces adhesion of the confectionery article to other articles that it may come in contact with in the package or the package itself. As such, the confectionery article may be an in process product, e.g. an intermediate product, or the final product.

Any suitable method may be used to apply the solid fat based material, so long as it is placed on the surface of the confectionery article. This must be performed in a manner that enables the solid fat based material to effectively perform its intended purpose of reducing adhesion and/or promoting flow of the confectionery articles. Suitable methods of applying the solid fat based material include, but are not limited to spraying, sprinkling, dusting, and the like.

The solid fat based material of the present invention is at least about 2 percent by weight (wt. %) fat. Preferably, it is at least about 8 wt. % fat. In a preferred embodiment, the fat content of the solid fat based material is between about 10 wt. % to about 40 wt. %. The solid fat based material may be any known or newly developed product or blend of materials that meets the above criteria. Moreover, it is desirable for the fat based material to be somewhat similar in recipe to a subsequent confectionery coating, e.g., chocolate. As mentioned above, it is added to confectionery articles to reduce adhesion and to improve the handling of the confectionery articles during processing and/or packaging. For example, the solid fat based material can be used to prevent confectionery centers from sticking to one another during storage. Alternatively, it can serve to improve the flow of the confectionery centers during panning or coating operations. Examples of such solid fat based materials include, but are not limited to, chocolate refinings, finished chocolate, cocoa powder, crystallized edible fats, peanut flour, and the like. Crystallized edible fats include, but are not limited to cocoa butter, palm, coconut, hydrogenated vegetable, partially hydrogenated vegetable, and the like. In addition, antibloom fats may be used as the solid fat based material. Non-limiting examples include, milk fats, coberine, and the like.

The preferred solid fat based material are chocolate refinings, which are obtained during the manufacture of chocolate. The chocolate refinings are about 17 wt. % to about 40 wt. % fat, preferably about 25 wt. % to about 40 wt. % fat, and more preferably about 26 wt. % to 30 wt. % fat. A refiner is used to reduce the particle size of solid particles in the chocolate to a predetermined size. The solid particles are typically comprised of cocoa mass particles, sugar crystals and milk solids. For example, a feed stream can be directed into the refiner, which typically includes the full chocolate recipe except for an emulsifier (often lecithin) and some or none of the fat, such as cocoa butter and/or milk fat. The discharge from the refining process is a powdery material that has a particle size from about 12 to about 60 microns. The recipe and taste of the chocolate refinings is very similar to the finished chocolate, but has a different texture.

Another preferred solid fat based material is cocoa powder. This is obtained from the pressed cake that is formed by removing part of the cocoa butter from cocoa liquor. The removal process is typically performed by mechanical pressing or other extraction means. The pressed cake may be ground or milled to produce particles of varying median sizes including powder. Cocoa powder typically has about 10-12% fat on the low side and 22-24% fat on the high side. It can be of various forms, such as natural or “dutched” chocolate, or washed or fermented cocoa powder.

Typically, the solid fat based material is utilized at temperatures below the melting point of the fat. Preferably, the temperature is at least about 3° C. below the melting point of the fat. More preferably, the temperature is at least about 8° C. below the melting point of the fat. As long as the solid fat based material can be processed within the guidelines provided above, the solid fat based material can be up to 100 percent fat. However, it is preferred that the solid fat based material be about 10 wt. % to about 40 wt. % fat.

The amount of solid fat based material that is added depends on the surface area of the confectionery articles to be covered. Generally, the solid fat based material is added to the confectionery article, e.g., an in process product (intermediate product), according to a weigh percent ratio of from about 0.1:99.9 to about 10:90. Preferably, the weight ratio is from about 0.5:99.5 to about 5:95. More preferably, from about 0.5:99.5 to about 3:97. It should be recognized, however, that the amount of the solid fat based material that should be applied to the confectionery article is that amount effective to substantially reduce adhesion between confectionery articles or between a confectionery article and a process surface.

The addition of the solid fat based material will form a layer over the confectionery center. As used herein, the term “layer” includes a substantially solid layer, a web, or discontinuous arrangement of particles, e.g., scattered particles that do not contact one another. The layer formed by the solid fat based material is from about 0.5 microns to about 2 mm thick. Preferably, the layer is about 10 microns to about 1 mm thick and more preferably, about 100 to about 500 microns thick.

The solid fat based material may be used in any suitable form so long as it spreads over the confectionery articles. Suitable forms include, but are not limited to, powders and flakes. The form that is used is largely determined by the application method. For example, if the fat based material is applied using spraying techniques, then a powder form will likely be used. The powder will likely be a very fine powder having a particle size from about 10 to about 150 microns. Preferably, the particle size is from about 10 microns to about 30 microns. Alternatively, the fat based material may be in the form of flakes, which are applied manually by introducing the flakes onto the product in a panning/coating operation. Another important consideration is the organoleptic properties of the powder. For example, particles that are about 30 microns or higher can often be detected in the mouth, producing a gritty mouth feel, which may not be desirable.

In a preferred embodiment, the solid fat based material is also one of the ingredients found in the confectionery product. As such, the addition of the fat based material, which acts as a processing aid, is virtually undetectable in the final product. Furthermore, since the solid fat based material is substantially similar to an ingredient that is found in the final product, the solid fat based material does not need to be identified or listed as a separate ingredient or processing agent on the ingredient label for the final product.

For example, if chocolate refinings are used as the solid fat based material in a confectionery article that has a chocolate surface, the chocolate refinings do not need to appear on the ingredient declaration. The ingredient declaration would list chocolate as an ingredient and the chocolate refinings would be encompassed under the heading of chocolate.

In a preferred embodiment, the confectionery articles are confectionery centers. The centers may be, for example, caramel, nougat, chocolate, truffle, fondant, taffy, fudge, and combinations thereof These type of center materials tend to be soft, sticky, and difficult to handle. This is particularly apparent, during processing and packaging operations. By applying a solid fat based material to the surface of the confectionery centers, the confectionery centers become more manageable and exhibit less adhesion problems when they are in contact with one another. Several advantages can be attributed to the use of the solid fat based material. First, it helps reduce the number of defects caused by centers that stick to one another. Second, it promotes greater uniformity of shape in the confectionery centers, i.e. shape retention. Third, it improves the efficiency of processing operations, by making it easier to handle the centers.

The shape retention benefit is directly related to the reduced adhesion benefit. Two materials can only adhere to each other at the point where they come in direct contact. For example, a true sphere, such as a confectionery center, and a flat horizontal surface, e.g., the wall of a piece of equipment, may contact each other at a tiny point, which may technically be a point so small that it has no dimension. However, if the sphere is prone to slumping under the stress of a shear force, such as gravity, there is the potential for the shape of the piece to change such that a larger contact area forms between the “sphere,” which is no longer truly spherical, and the flat surface. Since the adhesive force is proportional to the contact area (as well as other variables), this slumping, or deformation, results in increased adhesion. We have found that when refinings are used to thinly coat materials that are prone to slumping, for example caramel centers, this deformation is greatly reduced. Less deformation means less increase in contact area, which means less adhesion. The same is true in sphere to sphere contact (e.g., piece to piece adhesion).

When the confectionery articles are confectionery centers, the solid fat based material may be applied as described above or using the following method. The method comprises the steps of: (a) providing a sheet having confectionery centers throughout; (b) separating the confectionery centers from the sheet; and (c) applying a solid fat based material to the confectionery centers in an amount effective to substantially reduce adhesion when the confectionery centers are in contacting relationships.

In another embodiment, the method comprises the steps of: (a) providing a sheet having confectionery centers throughout; (b) applying a solid fat based material to the sheet of confectionery centers in an amount effective to substantially reduce adhesion when the confectionery centers are in contacting relationships; and (c) separating the confectionery centers from the sheet into discrete pieces.

Optionally, a mixing step may be included in any of the methods described, to facilitate the spread of the solid fat based material.

One method of breaking and/or separating the confectionery centers from the sheet is to place the sheet in a deflashing unit. The sheet has confectionery centers linked together in a web, which enters a perforated tube that has openings on each end of the tube, where the product can enter and exit the tube. The perforated tube rotates, tossing broken pieces of the sheet about and in the process, separates what remains of the sheet from the confectionery center pieces. The perforations in the tube wall are sized to be less than the diameter of the confectionery centers, so as to prevent the centers from falling out of the tube through the perforated holes.

After the solid fat based material is applied, the confectionery centers may be further processed. For example, the confectionery centers may be panned, coated, enrobed, expanded, conveyed, sprayed, or treated by any known or newly contemplated treatment. In a preferred embodiment, the confectionery centers are coated with an edible material such as, for example, chocolate, compound coatings, confectionery coatings, natural yogurt, artificial yogurt, and combinations thereof. In a preferred embodiment, the confectionery centers are coated with chocolate.

### EXAMPLE

A connected web of spherical pips is formed with a nougat-like material using chilled forming rolls. The mechanically stable web is not highly susceptible to deformation at temperatures below about 12° C., but exhibits significant adhesive forces (to other pieces, process surfaces, etc.) at temperatures above 5° C. At these temperatures (less than 5° C.), the web is broken in a deflashing unit, i.e. a rotating cylindrical drum with perforated walls, without significant adhesion between the pieces or with the drum walls. This results in deflashed (i.e. pieces without residual webbing) centers tumbling at the discharge end of the deflash unit. At the discharge end of the drum chocolate refinings are added as a flow agent. The chocolate refinings serve to reduce the adhesiveness of the nougat pieces, allowing them to be heated to a temperature (e.g., 12° C.) to allow further processing, such as chocolate coating. In the absence of the chocolate refinings, handling this material through the web forming, deflashing and further processing described herein would result in a unadhered mass fraction of 20% or less. By employing the invention described above, it is possible to retain an unadhered mass fraction of greater than 80%.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A method for reducing adhesion between confectionery articles stored or processed in contacting relationships, comprising the steps of:
applying a solid fat based material to said confectionery articles in an amount effective to substantially reduce adhesion when the confectionery articles are in contacting relationships, thereby reducing adhesion of said confectionery articles to one another.

2. The method of claim 1, wherein said solid fat based material is at least about 10 percent by weight fat.

3. The method of claim 1, further comprising the step of mixing said confectionery articles to increase coverage of said solid fat based material over said confectionery articles.

4. The method of claim 1, wherein said solid fat based material is applied by dusting.

5. The method of claim 1, wherein said confectionery articles are selected from the group consisting of confectionery centers, hard candies, jujubes, and mixtures thereof.

6. The method of claim 1, wherein said fat based powder is selected from the group consisting of chocolate refinings, finished chocolate, cocoa powder, crystallized edible fats, peanut flour, and mixtures thereof.

7. The method of claim 6, wherein said crystallized edible fats are selected from the group consisting of cocoa butter, palm, coconut, hydrogenated vegetable, partially hydrogenated vegetable, antibloom, and mixtures thereof.

8. The method of claim 1, wherein said solid fat based material has a particle size of from about 10 to about 30 microns.

9. The method of claim 1, wherein said solid fat based material is applied at a temperature of at least about 3° C. below the melting point of the solid fat based material.

10. The method of claim 1, wherein said solid fat based material is substantially similar to an ingredient in said confectionery article, such that said solid fat based material is not listed separately on an ingredient label of a package for said confectionery article.

11. A method for reducing adhesion of confectionery centers, comprising the steps of:
(a) providing a sheet having confectionery centers throughout;
(b) separating said confectionery centers from said sheet; and
(c) applying a solid fat based material to said confectionery centers in an amount effective to substantially reduce adhesion when said confectionery centers are in contacting relationships.

12. The method of claim 11, wherein said solid fat based material is at least about 10 percent by weight fat.

13. The method of claim 11, further comprising a step of (d) mixing said confectionery centers to increase coverage of said solid fat based material over said confectionery centers.

14. The method of claim 13, further comprising a step of (e) coating said confectionery centers with chocolate.

15. The method of claim 11, wherein said solid fat based material is applied by dusting.

16. The method of claim 11, wherein said separating step is performed in a deflashing unit.

17. The method of claim 11, further comprising a step of (d) coating said confectionery centers with chocolate.

18. The method of claim 11, wherein said fat based powder is selected from the group consisting of chocolate refinings, finished chocolate, cocoa powder, crystallized edible fats, peanut flour, and mixtures thereof.

19. The method of claim 18, wherein said crystallized edible fats are selected from the group consisting of cocoa butter, palm, coconut, hydrogenated vegetable, partially hydrogenated vegetable, antibloom, and mixtures thereof.

20. The method of claim 11, wherein said confectionery centers have a chocolate surface.

21. The method of claim 11, wherein said solid fat based material has a particle size of from about 10 to about 30 microns.

22. The method of claim 11, wherein said solid fat based material is applied at a temperature of at least about 3° C. below the melting point of the solid fat based material.

23. The method of claim 11, wherein said solid fat based material is substantially similar to an ingredient in said confectionery article, such that said fat based powder is not listed separately on an ingredient label of a package for said confectionery centers.

24. The method of claim 11, wherein said confectionery centers are selected from the group consisting of nougat centers, caramel centers, chocolate centers, fondant centers, truffle centers, taffy centers, fudge centers, and mixtures thereof.

25. A method for reducing adhesion of confectionery centers, comprising the steps of:
(a) providing a sheet having confectionery centers throughout;
(b) applying a solid fat based material to said sheet of confectionery centers in an amount effective to substantially reduce adhesion when the confectionery centers are in contacting relationships; and
(c) separating said confectionery centers from said sheet into discrete pieces.
